(19) United States
(12) Patent Application Publication
(10) Pub. No.: US 2013/0272368 A1
(43) Pub. Date: Oct. 17, 2013

(54) LOW POWER DATA RECOVERY USING OVER-CLOCKING

(71) Applicant: Wei-Lien Yang, Phoenix, AZ (US)

(72) Inventor: Wei-Lien Yang, Phoenix, AZ (US)

(21) Appl. No.: 13/991,615

(22) PCT Filed: Sep. 28, 2011
(86) PCT No.: PCT/US11/53738

§ 371 Date: Jun. 4, 2013

(51) Int. Cl. H04B 1/40

(52) U.S. Cl. CPC H04B 1/40
USPC 375/238; 375/340; 375/259

(57) ABSTRACT

Described herein are apparatus, system, and method for low power data recovery using over-clocking. The apparatus is a receiver that comprises an edge detector to detect a first falling edge and a first rising edge of an input signal received from a transmitter; a counter to count in a first direction in response to detecting the first falling edge, and to count in a second direction in response to detecting the first rising edge of the input signal, the counter to generate a final count value based on the counts in the first and second directions; and a decision unit to determine whether data in the input signal is of logical high or logical low value, the determination made according to the final count value, wherein the receiver and the transmitter are a Mobile Industry Processor Interface (MIPI®) M-PHY^{SM} receiver and transmitter.

### CLAIM OF PRIORITY

This application claims the benefit of priority of International Patent Application No. PCT/US2011/053738 filed Sep. 28, 2011, titled “Low Power Data Recovery Using Over-Clocking,” which is incorporated by reference in its entirety.

### FIELD OF THE INVENTION

Embodiments of the invention relate generally to the field low power input-output (I/O) transceivers. More particularly, embodiments of the invention relate to an apparatus, system, and method for low power data recovery using over-clocking.

### BACKGROUND

As power dissipation becomes a standard performance benchmark for consumer electronics, for example, tablet PCs, smart phones, low power laptops or net-books, etc, traditional high speed input-output (I/O) transceivers used in processors of such consumer devices (or any other low power device) are not optimum for low power operation. One reason for the traditional high speed I/O transceivers to be non-optimum architectures for low power operation is the use of clock data recovery (CDR) circuits in the receivers of the I/O transceivers. These CDR circuits include analog circuits, for example, delay locked loops (DLL), reference generators (e.g., bandgap or resistor ladders), phase locked loops (PLLs), and other analog and mix-signal circuits.

The above analog circuits dissipate direct current (DC) power during normal operation. While these analog circuits can be scaled down in size to operate at low frequencies, thus low power, the DC power consumption remains a bottleneck for low power consumption. Furthermore, such receiver architectures that use analog circuits, for example, DLLs, reference generators (e.g., bandgap or resistor ladders), PLLs, and other analog and mix-signal circuits, are unable to meet the stringent low power specifications of Mobile Industry Processor Interface (MIPI®) as described in the MIPI® Alliance Specification for M-PHY^{SM} Version 1.00.00 of Feb. 8, 2011 and approved on Apr. 28, 2011.

### BRIEF DESCRIPTION OF THE DRAWINGS

Embodiments of the invention will be understood more fully from the detailed description given below and from the accompanying drawings of various embodiments of the invention, which, however, should not be taken to limit the invention to the specific embodiments, but are for explanation and understanding only.

FIG. 1 is a high level system input-output (I/O) link with a receiver which is configured to recover data via low power logic units, according to one embodiment of the invention.

FIG. 2 is a pulse width modulated (PWM) waveform as used in the embodiments described herein.

FIG. 3 is a receiver architecture to provide data recovery via its low power logic units, according to one embodiment of the invention.

FIG. 4 is a set of waveforms of various signals of the receiver architecture, according to one embodiment of the invention.

FIG. 5 is a flowchart of a method to recover data via the low power logic units, according to one embodiment of the invention.

FIG. 6 is a detailed flowchart of a method to recover data via the low power logic units, according to one embodiment of the invention.

FIG. 7 is a system level diagram comprising a processor having the receiver with logic to recover data using over-clocking, according to one embodiment of the invention.

### SUMMARY

Embodiments of the invention relate to an apparatus, system, and method for low power data recovery using over-clocking.

In one embodiment, the apparatus is a receiver which comprises: an edge detector to detect a first falling edge and a first rising edge of an input signal received from a transmitter; a counter to count in a first direction in response to detecting the first falling edge, and to count in a second direction in response to detecting the first rising edge of the input signal, the counter to generate a final count value based on the counts in the first and second directions; and a decision unit to determine whether data in the input signal is of logical high or logical low value, the determination made according to the final count value.

In one embodiment, the system comprises the receiver discussed above, coupled to a transmitter; and a display unit to display a version of data encoded in the input signal.

In one embodiment, the method comprises: receiving an input signal from a transmitter; identifying a first falling edge and a first rising edge of the input signal; counting, by a counter, in a first direction in response to identifying the first falling edge, and counting in a second direction in response to identifying the first rising edge of the input signal; storing count value in response to identifying a second falling edge of the input signal, the second falling edge occurring in time after the first falling edge; and determining whether data in the input signal is of logical high or logical low value, the determining is made according to the stored count value.

In one embodiment, the receiver further comprises an over-sampler, coupled to the counter, to generate an over-sampled clock signal for the counter, wherein the over-sampler is operable to generate the over-sampled clock signal by generating pulse signals at the rising and falling edges of an input clock signal. In one embodiment, the receiver and the transmitter are a Mobile Industry Processor Interface (MIPI®) M-PHY^{SM} receiver and transmitter as functionally described in the MIPI® Alliance Specification for M-PHY^{SM} Version 1.00.00 of Feb. 8, 2011 and approved on Apr. 28, 2011. In one embodiment, the input signal is a pulse width modulated (PWM) as described in the MIPI® Alliance Specification for M-PHY^{SM} Version 1.00.00 of Feb. 8, 2011 and approved on Apr. 28, 2011.

### DETAILED DESCRIPTION

Embodiments of the invention relate to an apparatus, system, and method for low power data recovery using over-clocking. In one embodiment, the apparatus is a receiver that comprises an edge detector to detect a first falling edge and a first rising edge of an input signal received from a transmitter; a counter to count in a first direction in response to detecting the first falling edge, and to count in a second direction in response to detecting the first rising edge of the input signal, the counter to generate a final count value based on the counts in the first and second directions; and a decision unit to determine whether data in the input signal is of logical high or logical low value, wherein the determination made according to the final count value. In one embodiment, the receiver further comprises an over-sampler, coupled to the counter, to generate an over-sampled clock signal for the counter, wherein the over-sampler is operable to generate the over-sampled clock signal by generating pulse signals at the rising and falling edges of an input clock signal. In one embodiment, the receiver and the transmitter are a Mobile Industry Processor Interface (MIPI®) M-PHY^{SM} receiver and transmitter.

The technical effect of the receiver architecture discussed herein is that it provides low power data recovery independent of analog circuits, for example, clock data recovery (CDR) circuit are not used. The receiver architecture of the embodiments discussed herein is scalable to operate at low frequency as well as high frequency by changing the input clock frequency and/or the length of the counter. The term “low frequency” herein refers to the minimum GEAR specifications of MIPI®. Low frequency data transfers are in the range of 3-192 Mb/s. The term “high frequency” herein refers to the maximum GEAR specifications of MIPI®. High frequency data transfers are in the range of 9-576 MB/s. The term “GEAR” herein refers to a speed range of a pulse wave modulated signal as defined by specifications of MIPI®.

In the following description, numerous details are discussed to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

In the following description and claims, the term “coupled” and its derivatives may be used. The term “coupled” herein refers to two or more elements which are in direct contact (physically, electrically, magnetically, optically, etc.). The term “coupled” herein may also refer to two or more elements that are not in direct contact with each other, but still cooperate or interact with each other.

As used herein, unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

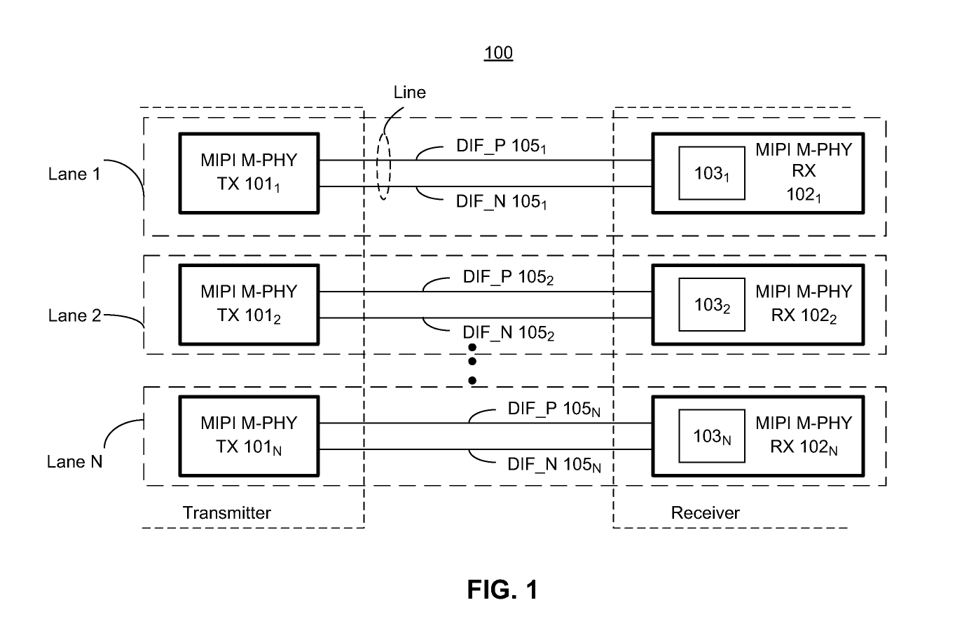

FIG. 1 is a high level system 100 input-output (I/O) link with a receiver which is configured to recover data via low power logic units, according to one embodiment of the invention. In one embodiment, each receiver (e.g., 102_{1-N}) includes a corresponding logic architecture 103_{1-N} for low power data recovery using over-clocking. While the system 100 is described herein as a MIPI® M-PHY^{SM} Link as defined by the MIPI® Alliance Specification for M-PHY^{SM} Version 1.00.00 of Feb. 8, 2011 and approved on Apr. 28, 2011, in other embodiments, the system 100 is any I/O link which is operable for low power data recovery at its receivers.

In one embodiment, the system 100 is a MIPI® M-PHY^{SM} Link which comprises MIPI® M-PHY^{SM} transmitters (M-TXs) 101_{1-N}, point-to-point interconnects DIF_P 105_{1-N} and DIF_N 105_{1-N}, and MIPI® M-PHY^{SM} receivers (M-RXs) 102_{1-N}. In the embodiments discussed herein, the M-RXs 102_{1-N} comprise logic architectures 103_{1-N} for low power data recovery using over-clocking. The system 100 comprises Lanes 1-N, where each lane includes a M-TX, M-RX, and a pair of point-to-point interconnects DIF_P and DIF_N that form a LINE. The term “DIF_P” and “DIF_N” herein refer to differential signals as defined by the MIPI® Alliance Specification for M-PHY^{SM} Version 1.00.00 of Feb. 8, 2011 and approved on Apr. 28, 2011.

In one embodiment, the transmitter and receiver of the system 100 are in different processors positioned in a consumer electronic (CS) device. In one embodiment, the CS device may be a tablet PC, a smart-phone, or any other low power consuming device. In one embodiment, the system 100 is coupled to a display unit (not shown) which is operable to display contents received by the receiver 102₁. In one embodiment, the display unit is a touch pad.

So as not to obscure the embodiments of the invention, TX 101₁, DIF_P 105₁, DIF_N 105₁, RX 102₁, and logic unit 103₁ are discussed. The discussion is applicable to other TX and RX of the system 100.

In one embodiment, the signals from the TX 101₁ are differential PWM signals (DIF_P 105₁ and DIF_N 105₁). In one embodiment, the RX 102₁ includes a first stage that converts the differential signals to a PWM single ended signal. In one embodiment, the PWM single ended signal is received by the logic unit 103₁ and converted into a Non-Return Zero (NRZ) signal for further processing.

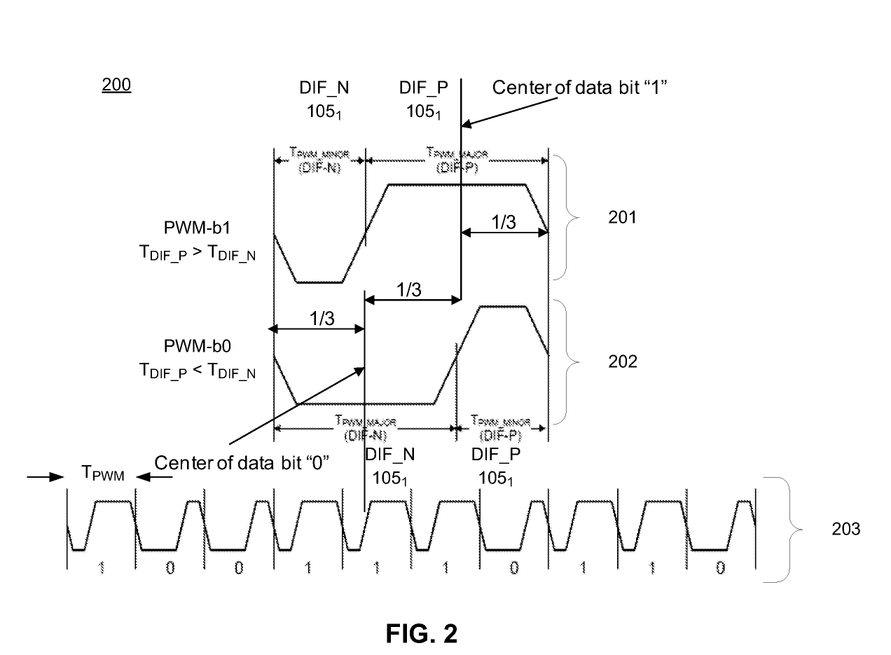

FIG. 2 is a pulse width modulated (PWM) waveform 200 as used in the embodiments described herein. PWM is a bit modulation scheme carrying data information in the duty cycle of the waveform. In one embodiment, the point-to-point interconnects DIF_P 105_{1-N} and DIF_N 105_{1-N} transmit PWM waveforms (also referred to as DIF_P 105₁ and DIF_N 105₁). The PWM scheme has self-clocking properties because the clock information is in the period of the PWM waveform 200. Each bit in the PWM waveform 200 consists of a combination of two sub-phases, a DIF_N 105₁ followed by a DIF_P 105₁. One of the two sub-phases is longer than the other, i.e. T_{PWM}_{_{—}}_{MAJOR}>T_{PWM}_{_{—}}_{MINOR}, depending on whether the bit in the PWM waveform 200 is a binary ‘1’ or a binary ‘0.’ The binary information in the PWM waveform 200 is in the ratio of the duration of the DIF_N 105₁ and DIF_P 105₁ states.

For example, if the LINE state is DIF_P for the majority of the bit period, the ‘n’ the bit is a binary ‘1’ 201 (PWM-b1). Likewise, if the LINE state is DIF_N for the majority of the bit period, the bit is a binary ‘0’ 202 (PWM-b0). The term “LINE” herein refers to the differential point-to-point differential serial connection.

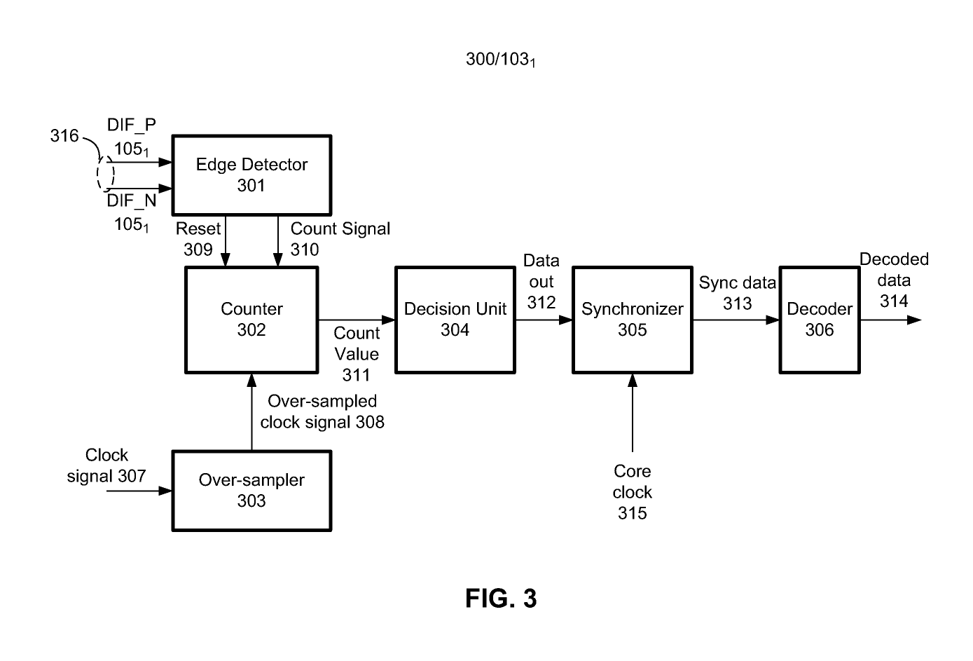

Each bit period of the PWM waveform 200 contains two edges, where the falling edge is at a fixed position and the rising edge position is modulated. Accordingly, the PWM bit stream 203 explicitly contains a bit clock with period T_{PWM}, which equals the duration of one bit. In one embodiment, the logic unit 103₁ (discussed with reference to FIG. 3) of the RX 102₁ is operable to process the PWM waveform 200 with low power data recovery using over-clocking.

FIG. 3 is logic unit 300/103₁ which is operable to provide data recovery via its low power logic units, according to one embodiment of the invention. The logic unit 103₁ is described with reference to FIGS. 1-2.

In one embodiment, the logic unit 103₁ comprises an edge detector 301, a counter 302, an over-sampler 303, a decision unit 304 and a synchronizer 305. In one embodiment, the logic unit 103₁ further comprises a decoder 306 to decode the synchronized data 313 from the synchronizer 305. In one embodiment, the decoder 306 is part of the receiver 102₁ and is not part of the logic unit 103₁.

In one embodiment, the edge detector 301 is operable to receive a PWM signal 316 having DIF_P 105₁ and DIF_N 105₁ and to detect a first falling edge and a first rising edge of the PWM signal 316 received from the TX 101₁. In one embodiment, the edge detector 301 generates a reset signal 309 in response to detecting the first falling edge of the PWM signal 316. In one embodiment, the reset signal 309 also corresponds to a count-down signal for the counter 302. In one embodiment, the edge detector 301 generates a count signal 310 in response to detecting the first rising edge of the PWM signal 316. In the embodiments discussed herein, the edge detector 301 is an all digital edge detector designed with logical combinational logic.

In one embodiment, the over-sampler 303 is operable to receive a clock signal 307 and to generate an over-sampled clock signal 308. The term “over-sampled” herein refers to sampling a signal at multiple points, for example, sampling the signal at the rising and falling edges of the signal. One benefit of the over-sampler 303 is that clock signal 307 can be at least twice as slow in frequency than necessary to provide a clock signal to the counter 302 because the over-sampler 303 generates an over-sampled clock 308 which is twice as fast in frequency than the clock signal 308. In one embodiment, the over-sampler 303 is a pulse generator which is operable to generate the over-sampled clock signal 308 by generating a pulse at every rising and falling edge of the clock signal 307. In one embodiment, the over-sampled clock signal 308 is input to the counter 302 and is used as a clock signal for the counter 302. In the embodiments discussed herein, the over-sampler 303 is an all digital over-sampler designed with logical combinational logic.

In one embodiment, the counter 302 is operable to count in response to receiving the reset signal 309 from the edge detector 301. In one embodiment, the counter 302 counts at every edge of the over-sampled clock signal 308. In one embodiment, the output of the counter 311 is used to determine the bit value of the PWM signal 316.

In one embodiment, the counter 302 is operable to count in a first direction in response to detecting the first falling edge, and to count in a second direction in response to detecting the first rising edge of the input signal. In one embodiment, the counter 316 is operable to generate a final count value based on the number of counts in the first and second directions. In one embodiment, the first and second directions are the same. In another embodiment, the first and the second directions are different, e.g., the first direction is count down direction while the second direction is count up direction.

In one embodiment, the first direction is a count down direction while the second direction is a count up direction of counting. In the embodiments discussed herein, the counter 302 is an up-down counter which is operable to count in the first direction (count down) and the second direction (count up). The technical effect of having an up-down counter and being able to count in one direction upon reset and another direction upon identifying the first rising edge of the PWM 316 signal is that the logic architecture 300/103₁ need not know the frequency of the PWM signal 316 and so the threshold levels used by the decision unit 304 can be kept constant.

However, the architecture 103₁ can be modified to operate with a counter that counts in one direction only (up or down) without changing the essence of the embodiments of the invention. In such an embodiment, the threshold levels in the decision unit 304 are modified to determine when the PWM signal 316 is a logical ‘1’ or a logical ‘0.’ For example, different threshold levels are selected according to the frequency of the PWM signal 316.

In one embodiment, the counter 302 is a shift register based counter. In other embodiments, other designs of the counter 302 may be used without changing the essence of the embodiments of the invention. In the embodiments discussed herein, the counter 302 is an all digital counter designed with logical combinational logic.

In one embodiment, the decision unit 304 is operable to compare the final count value 311 from the counter 302 to generate an output data signal 312 (logical ‘1’ or logical ‘0’). Let ‘M’ bits be the length of the counter 302. In one embodiment, the decision unit 304 causes the output signal 312 to be a logical ‘1’ if the value ‘N’ of the counter (indicated by count value 311) is greater or equal to (M/2+1). In such an embodiment, the decision unit 304 causes the output signal 312 to be a logical ‘0’ if the value ‘N’ of the counter is less than (M/2+1). In one embodiment, the value of ‘M’ is 24.

In one embodiment, the values of ‘M’ and ‘N’ are programmable by hardware or software, or a combination of both. In one embodiment, the values of ‘M’ and ‘N’ are programmable by hardware by changing voltage/current levels at pins of the processor comprising the receiver 103₁. In one embodiment, the values of ‘M’ and ‘N’ are programmable by software via Basic Input Output System (BIOS), operating system, or any other application configured to access settings of the receiver 102₁. In one embodiment, the value of ‘M’ and ‘N’ are predetermined by means of fuse signals at the time of manufacture of the receiver. In the embodiments discussed herein, the decision unit 304 is an all digital decision unit designed with logical combinational logic.

In one embodiment, the synchronizer 305 is operable to receive the data signal 312 from the decision unit 304 and synchronizes that data signal 312 to a clock signal 315 of the receiver. In one embodiment, the synchronizer 305 is a flip-flop or a latch which latches the data signal 312 on a rising or falling edge of the flip-flop or latch. The output of the synchronizer 305 is a synchronized data signal 313 which is synchronized with an edge of the receiver clock signal 315. In the embodiments discussed herein, the synchronizer 305 is an all digital synchronizer designed with logical combinational logic.

In one embodiment, the synchronized data 313 is decoded by a decoder 306 to generate decoded data 314 for further processing. In one embodiment, the decoder 306 is a Low Density Parity-Check Code (LDPC) decoder. In one embodiment, the decoder 306 is an Error Correction Code (ECC) decoder. In other embodiments, other forms of decoders may be used to decode the encoded PWM signal 316 received by the receiver 300/103₁. In the embodiments discussed above, no CDR is used and all logical blocks are digital logical blocks that do not consume

DC power consumed by comparable (by function) analog circuits. Furthermore, the design of the receiver 300/103₁ is scalable to a wide range of frequencies of the PWM signal 316 by changing the length ‘M’ of the counter and frequency of the clock signal 307.

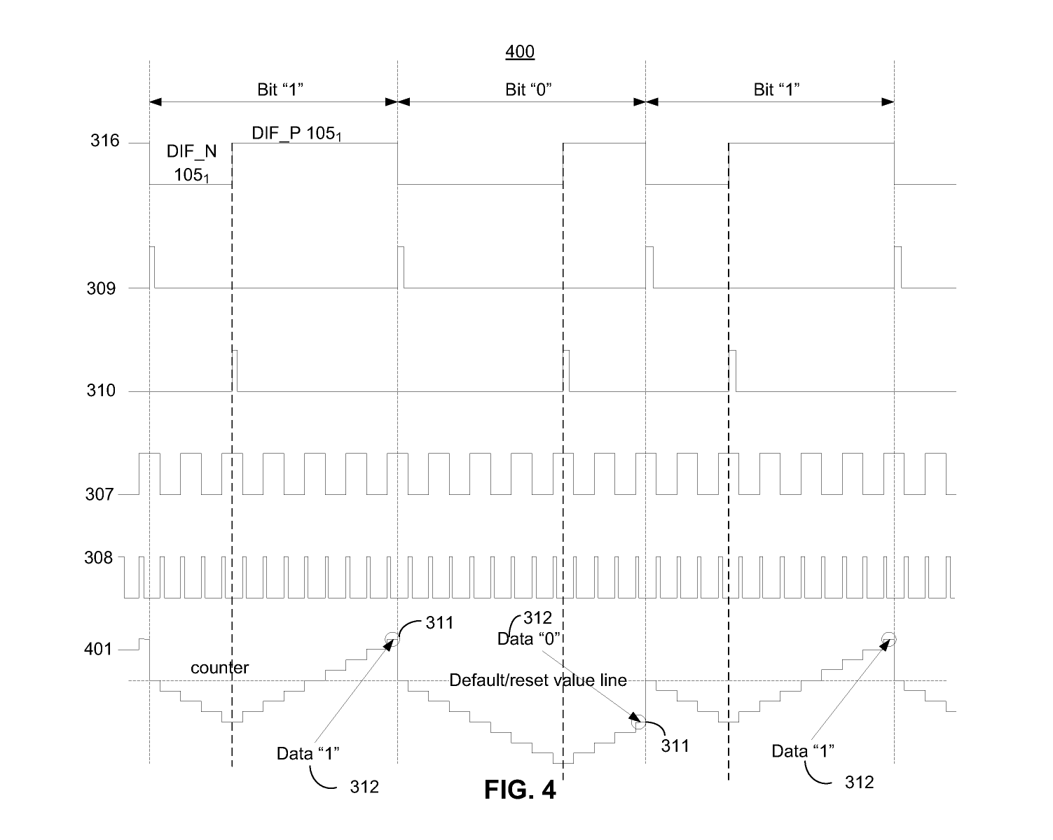

FIG. 4 is a set of waveforms 400 of various signals of the receiver architecture 103₁, according to one embodiment of the invention. The waveforms 400 are described with reference to FIGS. 1-3. For signals 316, 309, 310, 307, and 308, the x-axis is time while the y-axis is voltage. For signal 401, the x-axis is time while the y-axis is a count value.

The signal 316 is the PWM signal input to the receiver logic 103₁. As mentioned above, the PWM signal 316 consists of two parts—DIF_N 105₁ and DIF_P 105₁. The logic unit 103₁ determines whether the PWM signal 316 represents a logical bit ‘0’ or a bit ‘1.’ Signal 309 is the reset signal generated by the edge detector 301. The edge detector 301 identifies the first falling edge of the PWM signal 316 and generates a pulse signal 309 representing the first falling edge of the PWM signal 316. In one embodiment, when the counter 302 receives the reset signal 309, the counter 302 resets itself to a known count value. In one embodiment, the known count value is zero. In one embodiment, the counter 302 is an asynchronous reset counter such that the reset signal 309 when asserted, i.e. when the reset pulse is generated, the counter 302 resets without waiting for a rising/falling edge of a clock signal used by the counter 302. In one embodiment, the counter 302 is a synchronous reset counter such that the reset signal 309 when asserted, i.e. when the reset pulse is generated, the counter 302 resets on the next rising/falling edge of a clock signal (the over-sampled clock signal) used by the counter 302.

Signal 310 is the count signal generated by the edge detector 301. In one embodiment, the count signal 310 is a count up signal that causes the counter 302 to count up, i.e. count in the second direction. In one embodiment, the reset signal 309 is a count down signal that causes the counter 302 to count down, i.e. count in the second direction.

Signal 307 is the clock signal received by the over-sampler 303 which generates an over-sampled version of the clock signal 307. In one embodiment, the over-sampler 303 generates a pulse signal at every rising and falling edge of the clock signal 307 to generate the over-sampled clock signal 308. The over-sampled clock signal 308 is used as a counter clock signal for the counter 302 which causes the counter 302 to count up or down at every edge of the over-sampled clock signal 308. Signal 311 represents the final count value from the counter 302.

In one embodiment, the counter 302 resets on receiving a pulse 309 from the edge detector 301. In one embodiment, the decoder 306 samples the output of the synchronizer 313, which represents the previous data (decided as logical bit ‘1’ or bit ‘0’) stored in the counter 302, when the counter 302 receives the reset pulse 309 from the edge detector 301. In such an embodiment, the last count value 311 is stored and sent to the decision unit 304 for determination whether the previous PWM signal 316 is a logical bit ‘1’ or bit ‘0.’ If ‘N’ is greater or equal to (M/2+1) then the signal 312 from the decision unit 304 indicates that the previous data is a logical ‘1,’ else it is a logical ‘0.’ The synchronizer 305 then synchronizes this previous data for the decoder 306 to process. The counter 302 is then reset to N=M/2, which is the mid point of the counter count range.

While the embodiments discussed herein use an up-down counter 302 which is reset to its mid point M/2, the logic of 103₁ can be modified to work for a unidirectional counter 302 that counts either up or down and/or can be reset to any other known state. In one embodiment, the counter begins to count down from mid point M/2 upon receiving the pulse signal of 309. In such an embodiment, the counter 302 keeps counting down on every edge of the over-sampled clock signal 308 till the counter receives the pulse of the signal 310 (indicating the first rising edge of the PWM signal 316). The counter 302 then begins to count up till the next reset signal pulse 309 is identified. At that point, the final count value 311 is latched and the decision unit 304 makes a determination about the bit value of the PWM signal 316. If the count value 311 is above a certain threshold, then the bit value of the PWM signal 316 is identified as a logical ‘1’ or a logical ‘0’ value.

In one embodiment, the threshold used by the decision unit 304 is (M/2+1), where ‘M’ is the counter length. In such an embodiment, if the count value 311 is greater or equal to (M/2+1) then the decision unit 304 determines that the PWM signal 316 is a logical ‘1,’ else the PWM signal 316 is a logical ‘0.’

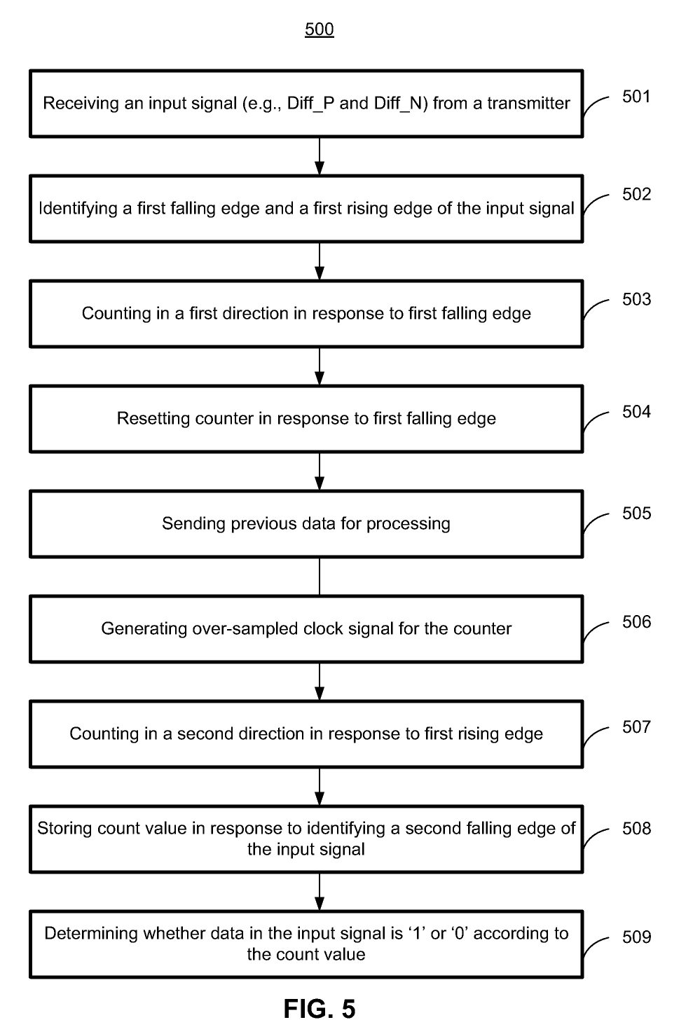

FIG. 5 is a flowchart 500 of a method to recover data via the low power logic units, according to one embodiment of the invention. Although the blocks in the flowchart 500 are shown in a particular order, the order of the actions can be modified. Thus, the illustrated embodiments can be performed in a different order, and some actions/blocks may be performed in parallel. Additionally, one or more actions/blocks can be omitted in various embodiments of recovering data by a receiver using an over-sampled clock signal. The flowchart of FIG. 5 is illustrated with reference to the embodiments of FIGS. 1-4.

At block 501, the edge detector 301 receives an input PWM signal 316 from a transmitter 101₁. At block 502, a first falling edge and a first rising edge of the PWM signal 316 are identified by the edge detector 301. The edge detector 301 then generates a reset signal (or count down signal) 309 upon detecting the first falling edge of the PWM signal 316. In one embodiment, the edge detector 301 generates a count up signal 310 upon detecting the first rising edge of the PWM signal 316. At block 503, the counter 302 begins to count in the first direction (e.g., down direction) in response to receiving a pulse f the first falling edge of the PWM signal 316.

At block 504, the counter 302 resets itself to a known value (e.g., mid-point M/2) in response to receiving the first falling edge of the PWM signal 316. At block 505, the synchronizer 305 sends the previously stored data to the decoder 306 for decoding. In such an embodiment, the last count value 311 is stored and sent to the decision unit 304 for determination whether the previous PWM signal 316 is a bit ‘1’ or bit ‘0.’ If ‘N’ is greater or equal to (M/2+1) then the signal 312 from the decision unit 304 indicates that the previous data is a ‘1,’ else it is a ‘0.’ The synchronizer 305 then synchronizes this previous data for the decoder 306 to process. The counter 302 is then reset to N=M/2.

At block 506, an over-sampled clock 308 is generated by the over-sampler 303. This over-sampled clock 308 is used by the counter 302 to count up or down. At block 507, the counter 302 counts in the second direction (e.g., up) in response to receiving a pulse of the first rising edge of the PWM signal 316. At block 508, the output of the counter 302 is stored in a latch or flip-flop for the decision unit 304 to determine whether the bit represented by the PWM signal 316 is a logical bit‘1’ or a bit ‘0.’ At block 509, the decision unit 304 determines whether the PWM signal 316 is a logical bit‘1’ or a bit ‘0.’

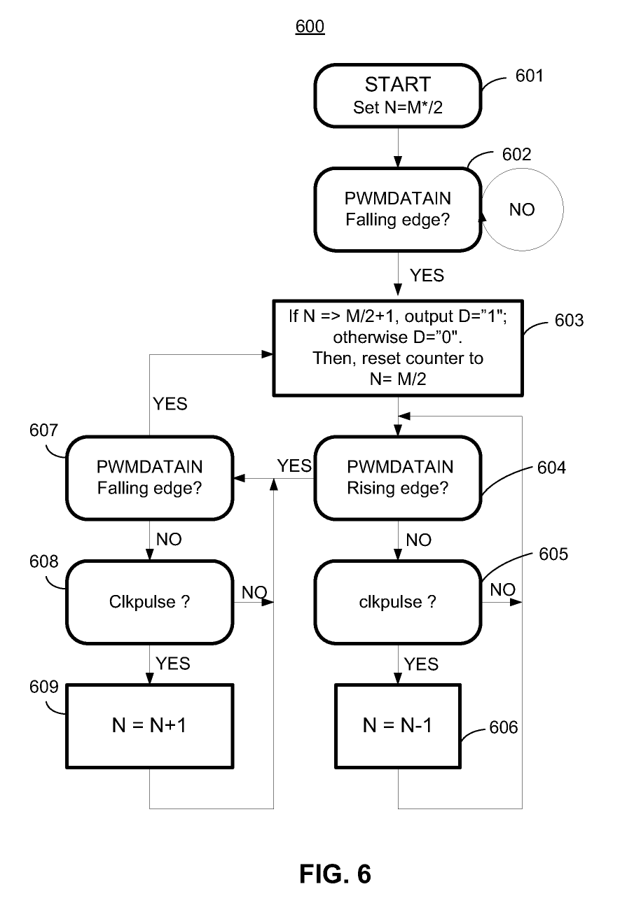

FIG. 6 is a detailed flowchart 600 of a method to recover data via the low power logic units, according to one embodiment of the invention. Although the blocks in the flowchart 500 are shown in a particular order, the order of the actions can be modified. Thus, the illustrated embodiments can be performed in a different order, and some actions/blocks may be performed in parallel. Additionally, one or more actions/blocks can be omitted in various embodiments of recovering data by a receiver using an over-sampled clock signal. The flowchart of FIG. 6 is illustrated with reference to the embodiments of FIGS. 1-4.

The process begins at block 601 when the values of ‘N’ and/or ‘M’ are set. In one embodiment, the values ‘N’ and/or ‘M’ are programmed by an operating system or by hardware settings on pins on a processor. In one embodiment, ‘N’ is set at M/2, where ‘M’ is the counter length of the counter 302, and where ‘N’ is the threshold used by the decision unit 304 to determine whether the PWM signal 316 is a bit ‘1’ or a bit ‘0.’ The counter 302 is then reset to N=M/2. At block 602, the edge detector 301 generates a reset signal 309 in response to determining the first falling edge of the PWM signal 316. Block 602 is repeated till the edge detector 301 determines the first falling edge of the PWM signal 316.

At block 603, the last count value 311 is stored and sent to the decision unit 304 for determination whether the previous PWM signal 316 is a logical bit ‘1’ or bit ‘0.’ In one embodiment, if ‘N’ is greater or equal to (M/2+1) then the signal 312 from the decision unit 304 indicates that the previous data is a logical bit ‘1,’ else it is a ‘0.’ The synchronizer 305 then synchronizes this previous data for the decoder 306 to process. The counter 302 is then reset to N=M/2.

At block 604, the edge detector 301 identifies another edge of the PWM signal 316 and determines whether that edge is the first rising edge of the PWM signal 316. If the edge is identified as the first rising edge, then the process transfers to block 607. If the edge detector 301 does not identify the first rising edge, i.e. no new edge has occurred after the first falling edge yet, then the process continues at block 605. At block 605, a determination is made whether the over-sampled clock signal 308 has any pulse. If there is no pulse then the counter 302 is not counted down. If there is a pulse in the over-sampled clock signal 308, then the counter is counted down by 1 at block 606, i.e. N=N−1, and the process continues to block 604.

At block 607, after the edge detector 301 determines the first rising edge of the PWM signal 316, the edge detector 301 looks for any new falling edge of the PWM signal 316. Because of the nature of the PWM signal 316 as described with reference to FIG. 2, the next new falling edge of the PWN signal 316 will indicate the beginning of a new PWM signal. If no new falling edge of the PWM signal 316 is determined upon the next over-sampled clock signal 308, then at block 609 the counter 302 is incremented by 1. At block 608, the over-sampled clock signal 308 is checked for any pulse. If no pulse is detected in the over-sampled clock signal 308, then the counter 302 is not incremented and the process transfers to block 607. During this process of 600, if the edge detector 301 determines a second falling edge, i.e. the new falling edge, then the process transfers to block 603. As mentioned above, at block 603, the last count value 311 is stored and sent to the decision unit 304 for determination whether the previous PWM signal 316 was a logical bit ‘1’ or bit ‘0.’ In one embodiment, if ‘N’ greater or equal to (M/2+1) then the signal 312 from the decision unit 304 indicates that the previous data is a logical ‘1,’ else it is a ‘0.’ The synchronizer 305 then synchronizes this previous data for the decoder 306 to process. The counter 302 is then reset to N=M/2.

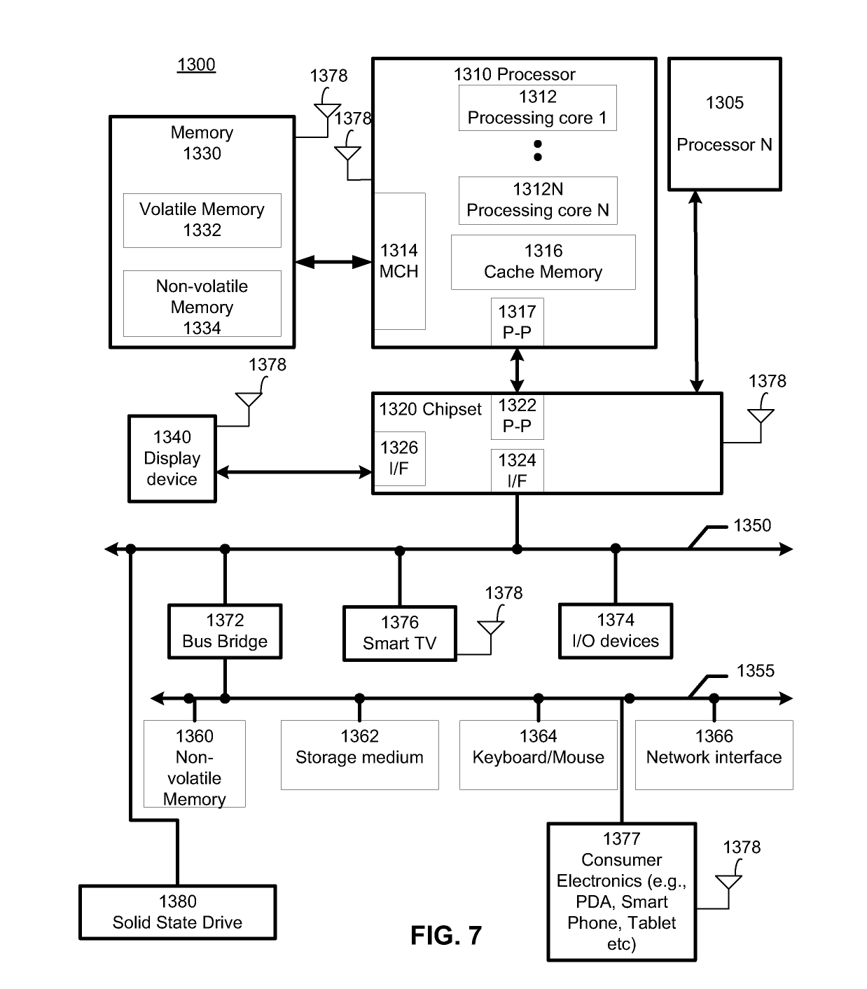

FIG. 7 is a system level diagram 1300 comprising a processor having a receiver to recover data (send by a transmitter) using over-sampled clock signal, according to one embodiment of the invention. FIG. 7 also includes a machine-readable storage medium to execute computer readable instructions to perform the methods of various embodiments. Elements of embodiments are also provided as a machine-readable medium for storing the computer-executable instructions (e.g., instructions to implement the processes discussed above and the flowchart of FIGS. 5-6). The machine-readable medium may include, but is not limited to, flash memory, optical disks, CD-ROMs, DVD ROMs, RAMs, EPROMs, EEPROMs, magnetic or optical cards, or other type of machine-readable media suitable for storing electronic or computer-executable instructions. For example, embodiments of the invention may be downloaded as a computer program (e.g., BIOS) which may be transferred from a remote computer (e.g., a server) to a requesting computer (e.g., a client) by way of data signals via a communication link (e.g., a modem or network connection).

In one embodiment, the system 1300 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance or any other type of computing device. In another embodiment, the system 1300 implements the methods disclosed herein and may be a system on a chip (SOC) system.

In one embodiment, the processor 1310 has one or more processer cores 1312 to 1312N, where 1312N represents the Nth processor core inside the processor 1310 where N is a positive integer. In one embodiment, the system 1300 includes multiple processors including processors 1310 and 1305, where processor 1305 has logic similar or identical to logic of processor 1310. In one embodiment, the system 1300 includes multiple processors including processors 1310 and 1305 such that processor 1305 has logic that is completely independent from the logic of processor 1310. In such an embodiment, a multi-package system 1300 is a heterogeneous multi-package system because the processors 1305 and 1310 have different logic units. In one embodiment, the processing core 1312 includes, but is not limited to, pre-fetch logic to fetch instructions, decode logic to decode the instructions, execution logic to execute instructions and the like. In one embodiment, the processor 1310 has a cache memory 1316 to cache instructions and/or data of the system 1300. In another embodiment of the invention, the cache memory 1316 includes level one, level two and level three, cache memory, or any other configuration of the cache memory within the processor 1310.

In one embodiment, processor 1310 includes a memory control hub (MCH) 1314, which is operable to perform functions that enable the processor 1310 to access and communicate with a memory 1330 that includes a volatile memory 1332 and/or a non-volatile memory 1334. In one embodiment, the memory control hub (MCH) 1314 is positioned outside of the processor 1310 as an independent integrated circuit.

In one embodiment, the processor 1310 is operable to communicate with the memory 1330 and a chipset 1320. In such an embodiment, the SSD 1380 executes the computer-executable instructions when the SSD 1380 is powered up.

In one embodiment, the processor 1310 is also coupled to a wireless antenna 1378 to communicate with any device configured to transmit and/or receive wireless signals. In one embodiment, the wireless antenna interface 1378 operates in accordance with, but is not limited to, the IEEE 802.11 standard and its related family, HomePlug AV (HPAV), Ultra Wide Band (UWB), Bluetooth, WiMAX, or any form of wireless communication protocol.

In one embodiment, the volatile memory 1332 includes, but is not limited to, Synchronous Dynamic Random Access Memory (SDRAM), Dynamic Random Access Memory (DRAM), RAMBUS Dynamic Random Access Memory

(RDRAM), and/or any other type of random access memory device. The non-volatile memory 1334 includes, but is not limited to, flash memory (e.g., NAND, NOR), phase change memory (PCM), read-only memory (ROM), electrically erasable programmable read-only memory (EEPROM), or any other type of non-volatile memory device.

The memory 1330 stores information and instructions to be executed by the processor 1310. In one embodiment, memory 1330 may also store temporary variables or other intermediate information while the processor 1310 is executing instructions. In one embodiment, chipset 1320 connects with processor 1310 via Point-to-Point (PtP or P-P) interfaces 1317 and 1322. In one embodiment, chipset 1320 enables processor 1310 to connect to other modules in the system 1300. In one embodiment of the invention, interfaces 1317 and 1322 operate in accordance with a PtP communication protocol such as the INTEL® QuickPath Interconnect (QPI) or the like.

In one embodiment, the chipset 1320 is operable to communicate with the processor 1310, 1305, display device 1340, and other devices 1372, 1376, 1374, 1360, 1362, 1364, 1366, 1377, etc. In one embodiment, the chipset 1320 is also coupled to a wireless antenna 1378 to communicate with any device configured to transmit and/or receive wireless signals.

In one embodiment, chipset 1320 connects to a display device 1340 via an interface 1326. In one embodiment, the display device 1340 includes, but is not limited to, liquid crystal display (LCD), plasma, cathode ray tube (CRT) display, or any other form of visual display device. In one embodiment of the invention, processor 1310 and chipset 1320 are merged into a single SOC. In addition, the chipset 1320 connects to one or more buses 1350 and 1355 that interconnect various modules 1374, 1360, 1362, 1364, and 1366. In one embodiment, buses 1350 and 1355 may be interconnected together via a bus bridge 1372 if there is a mismatch in bus speed or communication protocol. In one embodiment, chipset 1320 couples with, but is not limited to, a non-volatile memory 1360, a mass storage device(s) 1362, a keyboard/mouse 1364, and a network interface 1366 via interface 1324, smart TV 1376, consumer electronics 1377, etc.

In one embodiment, the mass storage device 1362 includes, but is not limited to, a solid state drive, a hard disk drive, a universal serial bus flash memory drive, or any other form of computer data storage medium. In one embodiment, network interface 1366 is implemented by any type of well known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, HomePlug AV (HPAV), Ultra Wide Band (UWB), Bluetooth, WiMAX, or any form of wireless communication protocol.

While the modules shown in FIG. 7 are depicted as separate blocks within the system 1300, the functions performed by some of these blocks may be integrated within a single semiconductor circuit or may be implemented using two or more separate integrated circuits. For example, although the cache memory 1316 is depicted as a separate block within the processor 1310, the cache memory 1316 can be incorporated into the processor core 1312 respectively. In one embodiment, the system 1300 may include more than one processor/processing core in another embodiment of the invention.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

While the invention has been described in conjunction with specific embodiments thereof, many alternatives, modifications and variations of such embodiments will be apparent to those of ordinary skill in the art in light of the foregoing description.

In one embodiment, the counter 302 counts in one direction, i.e. both the first and the second directions are the same. While this alternative embodiment is described in terms of counting up, the same embodiment can be modified for counters that count down. In one embodiment, the counter 302 begins to count upon reset which occurs when detecting the first falling edge of the input PWM signal 316. In one embodiment, the counter 302 stops counting when the first rising edge of the PWM signal 316 is identified. The output 311 of the counter 302 is then fed into the decision unit 304 which compares the count value 311 with a threshold value. In one embodiment, the threshold value is a programmable value. In one embodiment, the threshold value depends on the speed (or frequency) of the input PWM signal 316.

In one embodiment, for higher the frequencies of the PWM signal 316, lower threshold values are used. One reason for lower thresholds is that the counter 302 has less time to count. In such an embodiment, for lower frequencies of the PWM signal 316, higher threshold values are used because the counter 302 has more time to count. In one embodiment, the decision unit 304 reads a lookup table (not shown) and determines which threshold to use based on the frequency of the PWN signal 316. In one embodiment, the lookup table entries are programmable. In one embodiment, a frequency detector is also included in the logic architecture 300/103 and its output is used by the decision unit 304 to determine the appropriate threshold to use for comparison by the decision unit 304. In one embodiment, if the count value 311 is higher than the threshold, then the decision unit 304 determines that the PWM signal 316 is a logical ‘1’ signal 312, else a logical ‘0’ signal 312.

The embodiments of the invention are intended to embrace all such alternatives, modifications, and variations as to fall within the broad scope of the appended claims.

1. A receiver comprising:
an edge detector to detect a first falling edge and a first rising edge of an input signal received from a transmitter;
a counter to count in a first direction in response to detecting the first falling edge, and to count in a second direction in response to detecting the first rising edge of the input signal, the counter to generate a final count value based on the counts in the first and second directions; and
a decision unit to determine whether data in the input signal is of logical high or logical low value, the determination made according to the final count value.

2. The receiver of claim 1 further comprises:
an over-sampler, coupled to the counter, to generate an over-sampled clock signal for the counter.

3. The receiver of claim 2, wherein the over-sampler is operable to generate the over-sampled clock signal by generating pulse signals at the rising and falling edges of an input clock signal.

4. The receiver of claim 3 further comprises a flip-flop or a latch to latch an output of the decision unit by one of the rising or falling edges of the input clock signal.

5. The receiver of claim 1, wherein the input signal is a pulse width modulated (PWM) signal.

6. The receiver of claim 1, wherein the transmitter is a MIPI® M-PHY^{SM} transmitter.

7. The receiver of claim 1, wherein the first direction is different from the second direction.

8. The receiver of claim 1, wherein the first direction is same as the second direction.

9. A system comprising:
a receiver, coupled to a transmitter, the receiver comprises:
an edge detector to detect a first falling edge and a first rising edge of an input signal received from the transmitter;
a counter to count in a first direction in response to detecting the first falling edge, and to count in a second direction in response to detecting the first rising edge of the input signal, the counter to generate a final count value based on the counts in the first and second directions; and
a decision unit to determine whether data in the input signal is of logical high or logical low value, the determination made according to the final count value; and
a display unit to display a version of the data.

10. The system of claim 9, wherein the display unit is a touch pad.

11. The system of claim 9, wherein the receiver further comprises:
an over-sampler, coupled to the counter, to generate an over-sampled clock signal for the counter.

12. The system of claim 11, wherein over-sampler is operable to generate the over-sampled clock signal by generating pulse signals at the rising and falling edges of an input clock signal.

13. The system of claim 9, wherein the receiver further comprises a flip-flop or a latch to latch an output of the decision unit by one of the rising or falling edges of the input clock signal.

14. The system of claim 9, wherein the input signal is a pulse width modulated (PWM) signal.

15. The system of claim 9, wherein the receiver and the transmitter are a MIPI® M-PHY^{SM} receiver and transmitter.

16. The system of claim 9, wherein the first direction is different from the second direction.

17. The system of claim 9, wherein the first direction is same as the second direction.

18. A method comprising:
receiving an input signal from a transmitter;
identifying a first falling edge and a first rising edge of the input signal;
counting, by a counter, in a first direction in response to identifying the first falling edge, and counting in a second direction in response to identifying the first rising edge of the input signal;
storing count value in response to identifying a second falling edge of the input signal, the second falling edge occurring in time after the first falling edge; and
determining whether data in the input signal is of logical high or logical low value, the determining is made according to the stored count value.

19. The method of claim 18 further comprises:
resetting the counter in response to identifying the first falling edge;
sending previous data for processing in response to resetting the counter; and
generating an over-sampled clock signal for the counter, the counter to count on every rising or falling edge of the over-sampled clock signal.

20. (canceled)

21. The method of claim 18, wherein the first direction is different from the second direction, or wherein the first direction is same as the second direction.

22. (canceled)

23. (canceled)

24. (canceled)
